(19) United States
(12) Patent Application Publication
(10) Pub. No.: US 2007/0259685 A1
(43) Pub. Date: Nov. 8, 2007

(54) ELECTRONIC EQUIPMENT WITH KEYLOCK FUNCTION USING MOTION AND METHOD

(76) Inventors: Goran Engblom, Kristianstad (SE); Johan Nerman, Sodra Sandby (SE); Tony Tillerkvist, Kristianstad (SE); Goran Schack, Ahus (SE); Carl-Magnus Hylen, Sjobo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/422,692

(22) Filed: Jun. 7, 2006

Related U.S. Application Data
(60) Provisional application No. 60/746,683, filed on May 8, 2006.

(51) Int. Cl. H04M 1/00

(52) U.S. Cl. 455/550.1

(57) ABSTRACT

Electronic equipment, such as a mobile phone, PDA or other device, is operative to turn on and to turn off keylock function or another function or to alter a characteristic of such function in response to shaking or other movement of the electronic equipment, e.g., when the mobile equipment is shaken at a given frequency and amplitude, according to a given code, in a given direction, e.g., twisting/twirling and/or in an arcuate path or linear path. The electronic equipment includes a motion transducer providing motion signals representing motion and a comparator that compares motion signals to determine whether they match predetermined or programmed motion signals.

A method of turning on or off or altering a function or a characteristic of a function of electronic equipment includes detecting occurrence of motion and in response thereto carrying out the turning on, turning off and/or altering if that motion matches a predetermined or programmed motion. The method may include shaking the electronic equipment in a hand, moving the electronic equipment linearly, in an arc, in a rotation, etc. The electronic equipment may be programmed with the predetermined motion.

### TECHNICAL FIELD OF THE INVENTION

The present invention relates generally to electronic equipment, and, more particularly, to electronic equipment with keylock function using motion and method of keylock using motion, e.g., shaking or other intended motion.

### DESCRIPTION OF THE RELATED ART

Many mobile phones, personal digital assistants (PDAs), and other electronic equipment have one or more key lock functions (sometimes referred to as “keylock”) to lock one or more of the keys, buttons, switches, etc. from full or partial operation. For example, the key pad keys, e.g., the keys of a mobile phone that are pressed to input a telephone number that is to be dialed or called, a function key, such as, for example, the send/transmit key that causes a telephone number being dialed to initiate a telephone call, a soft key, e.g., a key that selects and/or initiates a function according to what may be shown on the displayed menu of the mobile phone, the on/off key that controls power to the mobile phone, etc., may be locked to prevent inadvertent operation while the mobile phone is in a user's pocket or briefcase or when an object is placed against the mobile phone. Another reason that the keys of a mobile phone may be locked is to prevent an unauthorized person from using the mobile phone. Sometimes only one or several keys (but not all keys) of a mobile phone may be locked; for example, some keys may be locked to prevent initiating a phone call while allowing one or more other keys to be unlocked or partially unlocked, e.g., to permit an incoming phone call to be answered. Another reason to lock some keys may be to prevent an unauthorized person from accessing the internet from a mobile phone while still allowing the usual telephone call initiating and answering functions. There also may be other reasons to lock or partially to lock keys of a mobile phone. The locked or partially locked keys may be unlocked for use.

To lock the keys, e.g., those of the dialing keypad and/or other keys, of a mobile phone, usually a sequence of pressing two or more keys is required. Similarly, to unlock the keys, a sequence of pressing two or more keys usually is required. For example, a sequence of a function key and one or more key pad keys may have to be pressed to lock a mobile phone, and the same or a different sequence may have to be pressed to unlock the mobile phone. On some mobile phones to lock keys a lock function has to be selected from a menu of functions that are shown on the mobile phone display, and to unlock the mobile phone a sequence of pressing two or more keys is required. The above are only several examples of techniques for locking and unlocking mobile phones.

A disadvantage to many prior techniques for locking and unlocking mobile phones is that it may be inconvenient to press the sequence of keys to achieve locking or unlocking. For example, the keys may not be seen because a room is dark and the keys are unlit or because of a visual impairment of the user. Also, a user may forget the sequence of keys that has to be pressed to lock or to unlock a mobile phone.

Keylock function may be annoying. Some users of mobile phones may feel that when keylock is needed it is off (not preventing mobile phone use); and when it is not wanted, it is on (preventing mobile phone use).

### SUMMARY

In view of the aforementioned shortcomings associated with conventional approaches to keylock there is a need in the art to facilitate turning on and off keylock. There also is a need to facilitate the way in which keylock is turned on and off while still maintaining security.

An aspect of the invention relates to an electronic equipment including a transducer, wherein the transducer is operable to detect motion of the electronic equipment, the electronic equipment having at least one operational function, and wherein the operational function or a characteristic of the operational function is responsive to detected motion at least one of to be turned on, to be turned off or to be altered.

According to another aspect, the operational function is keylock, and if the keylock function off detected motion turns on the keylock function and if the keylock function is on detected motion turns off the keylock function.

According to another aspect, the electronic equipment is a mobile phone.

According to another aspect, the electronic equipment includes a setup function operable to set up a prescribed motion detectable to turn on or to turn off the keylock function of the mobile phone.

According to another aspect, an electronic equipment includes a transducer, wherein the transducer is operable to detect motion of the electronic equipment, and a keylock, wherein the keylock turns on or turns off an operational function of the electronic equipment in response to the detected motion.

According to another aspect, the transducer is responsive to a predetermined motion, and the keylock is operational to turn on or to turn off the operational function of the equipment only in response to such predetermined motion being detected.

According to another aspect, the electronic equipment is a mobile phone.

According to another aspect, the electronic equipment is at least one of a mobile phone and a PDA.

According to another aspect, the transducer is operable to detect shaking.

According to another aspect, the transducer including an accelerometer.

According to another aspect, the transducer including a signal conditioning circuit to filter out signals representing motion not representative of intended motion of the electronic equipment.

According to another aspect, the signal conditioning circuit including a low pass filter.

According to another aspect the transducer including a signal variation detector.

According to another aspect, the electronic equipment includes a programmable device responsive to a motion input, whereby a determined motion of the electronic equipment may be used to establish the detectable motion required to be detected to turn on or to turn off the operational function.

According to another aspect, a method of activating and deactivating a function of electronic equipment, includes moving an electronic equipment, detecting such moving, and in response to the moving at least one of turning on, turning off or altering a characteristic of the function.

According to another aspect the method includes detecting the character of movement of such electronic equipment, comparing such movement with an already determined character of movement, and in response to such movements being at least substantially the same turning on, turning off or altering a characteristic of the function.

According to another aspect, the moving including manually shaking.

According to another aspect, the turning, turning off or altering a characteristic of the function comprises turning on, turning off or altering a characteristic of keylock of a mobile phone.

According to another aspect, the method includes the step of setting up the electronic equipment to establish the determined character of movement to which subsequent movement may be compared to determine whether to turn on, to turn off or to alter a characteristic of the function.

According to another aspect, the method includes detecting for variations in signals produced by two electronic equipment for use in determining whether to establish communication therebetween.

According to another aspect, a method for programming electronic equipment to be responsive to motion to at least one of turn on, turn off or to alter a function or a characteristic of a function, includes moving the electronic equipment in a desired manner to establish the determined character of movement to which subsequent movement may be compared to determine whether at least one of to turn on, to turn off or to alter a function or a characteristic of the function.

According to another aspect, a computer program operable in electronic equipment, includes code to operate the electronic equipment to detect the character of motion of such electronic equipment, code to cause comparing of the character of motion of such electronic equipment with a determined motion signal representing determined motion, and code for causing at least one of turning on, turning off or altering of a function of the electronic equipment when the character of motion of such electronic equipment and such determined motion signal represent substantially the same motion.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the annexed drawings several exemplary embodiments of the invention are illustrated, it being understood that such illustrations are not necessarily to scale.

FIG. 1 is schematic illustration of a mobile phone with keylock function based on motion;

FIG. 2 is a schematic block diagram illustrating a method in accordance with an embodiment of the present invention;

FIG. 3 is a schematic block diagram of a number of exemplary relevant portions of the mobile phone of FIG. 1 in accordance with an embodiment of the present invention;

FIGS. 4, 5 and 6 are, respectively, schematic illustrations of motion transducers providing for motion detection based on threshold, amplitude, or frequency;

FIG. 7 is a schematic flow chart representing an exemplary method showing the relevant operation of the electronic equipment in accordance with an embodiment of the present invention;

FIG. 8 is a schematic illustration of a menu of functions able to be presented on a display of electronic equipment in accordance with an embodiment of the invention; and

FIG. 9 is a schematic flow chart representing an exemplary method showing setting up or programming predetermined motion of the electronic equipment; and

FIG. 10 is a schematic illustration of a PDA as embodiment of the invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” “mobile phone,” “mobile device,” or “mobile terminal” and the like, includes all equipment such as mobile telephones, pagers, communicators, i.e., electronic organizers, personal digital assistants (PDAs), smartphones, portable communication apparatus or the like. The term “electronic equipment” also may include portable digital music devices, e.g., iPod devices, mp3 players, etc. A portable radio communication device may also be a portable digital music device.

In the present application, the invention is described primarily in the context of a mobile telephone. However, it will be appreciated that the invention is not intended to be limited to a mobile telephone and can be any type of electronic equipment.

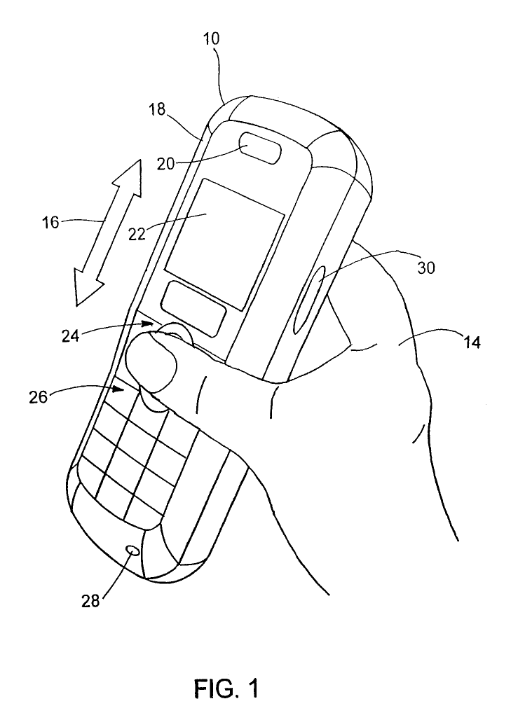

Referring initially to FIG. 1, electronic equipment 10 is illustrated being held in a hand 14 of a person. A double-ended arrow 16 represents motion of the electronic equipment 10 as it is moved by the hand 14. By moving the electronic equipment 10 keylock can be turned on to lock and turned off to unlock part or all of the functions of the electronic equipment. In an embodiment motion also may be used to turn off the electronic equipment entirely or to turn off the electronic equipment almost entirely, while allowing the mobile phone subsequently to be turned on by motion. As is described further below, the motion may be of a character that is detectible, e.g., a prescribed number of shakes (e.g., movements of the electronic equipment) in a given direction, shaking at a prescribed frequency, shaking in a given direction, e.g., an arc, one or more specified linear directions, etc., shaking in a prescribed pattern, e.g., as in code, such as a prescribed number of quick shakes followed by a prescribed duration in time when the electronic equipment is not moved, and then a prescribed number of shakes. These are only some examples of motion useful in various embodiments of the invention, and it will be appreciated that others are possible. It is noted that the terms “shaking” and “motion” may be used equivalently below, as will be evident from context.

In the exemplary embodiment illustrated in FIG. 1 and described herein, the electronic equipment 10 is a mobile phone (also referred to as mobile telephone and sometimes referred to as cell phone, satellite phone, and by other terminology, as will be appreciated by those having ordinary skill in the art). Although the invention is described with respect to mobile phones, and the electronic equipment 10 will be referred to below as mobile phone, it will be appreciated that the invention is applicable to other electronic equipment, such as, for example, personal digital assistants (PDAs), and other electronic equipment, whether currently existing or developed in the future, and several non-limiting examples are mentioned elsewhere herein.

From the description summarized above and described in further detail below, it will be appreciated that lock and unlock functions may be performed in response to motion of the mobile phone using motion sensing and comparing functions of the present invention. The lock and unlock functions may be used to lock part or all of a mobile phone from use and to unlock part or all of a mobile phone for use. For example, the mobile phone may be turned on or off; the key pad (e.g., the keys used for dialing) may be turned on or off; dialing or sending a telephone number to initiate a telephone call may be turned on or off while still permitting the mobile phone to receive and to answer an incoming phone call; and/or answer function may be turned on or off. Internet functions and/or other functions of the mobile phone also may be turned on or off. Another function may be to mute or to unmute the mobile phone, e.g., to turn off or to turn on the microphone thereof. These are only examples of functions that may be turned on and off; it will be appreciated that there may be other functions that may be turned on and off. The description below refers to turning on and off keylock; but it will be appreciated that other operational functions or operating functions, e.g., as was described just above, and still others also may be turned on or off based appropriate motion of the mobile phone occurring and being detected. It will be appreciated that the term “function” or “functions” also may be referred to equivalently as “operational function” or “operational functions” of the mobile phone in that a given function may be a characteristic or operational capability of the mobile phone. Further, it will be appreciated that reference to turning on or turning off function(s) or the like may be understood as enabling and disabling, respectively, or activating and disabling (or deactivating), respectively, the function(s). Furthermore, reference to turning on, turning off, enabling, disabling, activating and disabling (or deactivating) may also include the possibility that and may be considered as also defined as the character of a given function is altered from one state to another; for example, altering the function of volume of a speaker, altering the number of keys on a keypad that may be used, e.g., to allow pressed numeric keys to provide a useful functional output signal while precluding any useful outputs from the asterisk (*) or “pound” (sometimes referred to as “number,” “number sign,” or “hash” (#) keys, which sometimes are used particularly to provide some type of computer input signal, etc. These are only several examples of turning on, turning off, and altering functions, and there may be others.

The mobile phone 10 is shown as having a “brick” or “block” design type housing 18, but it will be appreciated that other type housings, such as, for example, claim shell or slide-type housings, may be utilized without departing from the scope of the invention. The mobile phone 10 includes the housing 18 (sometimes referred to as a case), speaker 20, display 22, navigation switch and selection/function keys or switches 24, keypad 26, microphone 28, and volume control slide switch 30; these are illustrative and exemplary of parts of a typical mobile phone, but it will be appreciated that other parts that are similar or different in form and/or function may be included in the mobile phone 10. The mobile phone to which the invention pertains also may be of a type that has more or fewer functions, keys, etc. compared to those illustrated and described in detail herein.

As will be appreciated, the mobile phone 10 may function as a conventional mobile phone. The mobile phone 10 may have additional functions and capabilities that may be developed in the future. From a conventional point of view, the display 22 displays information to a user, such as operating state, time, phone numbers, contact information, various navigational menus, etc. which facilitate and/or enable the user to utilize the various features of the mobile phone. Part or all of the display 22 may be a touch screen type device 22a (FIG. 3). The navigation and function keys 24 and the keypad 26 may be conventional in that they provide for a variety of user operations. For example, one or more of the function keys and navigation device 24 may be used to navigate through a menu displayed on the display 22 to select different phone functions, profiles, settings, etc., as is conventional. The keypad 26 typically includes one or more special function keys, such as, a “call send” key for initiating or answering a call, a “call end” key for ending or hanging up a call, and dialing keys for dialing a telephone number. Other keys included in the navigation and function keys 24 and/or keypad 26 may include an on/off power key, a web browser launch key, a camera key, a voice mail key, a calendar key, etc. The volume control switch 30 may be operated to increase or to decrease the volume of the sound output from the speaker 20. If desired, a sensitivity control also may be provided to change the sensitivity of the microphone 28 as it picks up sounds for transmission by the mobile phone 10. The mobile phone 10 may have more of fewer keys, navigation devices, etc. compared to those illustrated.

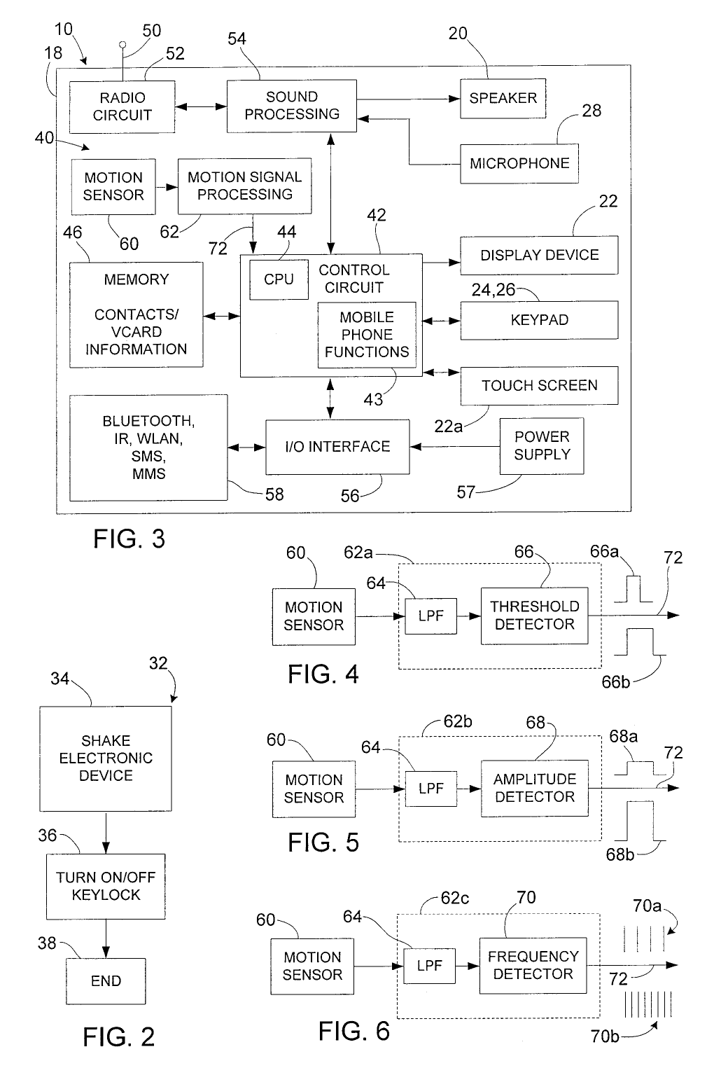

Briefly referring to FIG. 2, a method of using and carrying out the invention is illustrated schematically in a block diagram 32. At step 34 (sometimes referred to as block e.g., as a block in a flow chart, function diagram or logic diagram, etc.) the mobile phone 10 is shaken. For example, a user, whose hand 14 is holding the mobile phone 10, may move the phone up and down or in some other manner, e.g., sideways, in a circular pattern, twisting, rotating, etc. The motion may be according to a particular frequency, amplitude or duration, number of shakes, etc. The motion may be detected by the mobile phone, and if the detected motion is appropriate, e.g., is that motion to which the mobile phone responds to turn on or off keylock, then at block 36 keylock is turned on or off. For example, if keylock was off, the appropriate detected motion will turn on keylock; and if keylock was on, the appropriate motion will turn off keylock. At block 38 the keylock turning on or turning off function has been completed and the method may be ended leaving the mobile phone keylock on or off until the next appropriate motion is detected.

The motion may be a shaking motion, an acceleration or some other type of intended motion. Intended motion means that motion intended so as to carry out the functions of the invention as compared to casual motion occurring due to walking, jogging or even riding in a vehicle or as compared to random motion, such as raising a mobile phone to the ear of a user or some other type of motion that may be considered noise or the like.

FIG. 3 represents a functional block diagram of an exemplary mobile phone, for example, the mobile phone 10. The representation also may be for other mobile phones, too. The representation also is similar to those of PDAs and/or other electronic equipment, as will be appreciated by those having ordinary skill in the art. The construction of the mobile phone 10, which is presented by way of example here, is generally conventional with the exception of the capability provided by a motion transducer 40 and use of information provided by the motion transducer, as are described in greater detail below. The various functions carried out by the parts represented in the functional block diagram of FIG. 3 may be carried out by application software within the mobile phone 10. However, it will be apparent to those having ordinary skill in the art that such operation can be carried out via primarily software, hardware, firmware, or a combination thereof, without departing from the scope of the invention.

The mobile phone 10 includes a primary control circuit 42 that is configured to carry out overall control of the functions and operations of the mobile phone 10, e.g., as is represented at block 43. The control circuit 42 may include a CPU 44 (central processor unit), microcontroller, microprocessor, etc., collectively referred to herein simply as CPU 44. The CPU 44 executes code stored in memory within the control circuit 42 (not shown) and/or in a separate memory 46 in order to carry out conventional operation of the mobile phone functions within the mobile phone 10. In addition, the CPU 44 executes code stored in the memory 46, for example, or in some other memory (not shown) in accordance with the present invention in order to perform the various functions of detecting motion based on signals provided by the motion transducer 40, carrying out comparisons of the motion signals or information, e.g., as a comparator, and controlling keylock, e.g., turning keylock on or off, when appropriate motion information has been received.

Continuing to refer to FIG. 3, the mobile phone 10 includes a conventional antenna 50, radio circuit 52, and sound processing signal circuit 54, all of which are cooperative to send and to receive radio frequency (or other) signals in conventional manner. For an incoming signal, for example, the sound processing signal circuit 54 may include an amplifier to amplify the signal and to provide it to the speaker 20 so a user may hear the sound, and the sound processing signal circuit 54 also may use the same amplifier or another amplifier to amplify signals from the microphone 28 for transmitting thereof via the radio circuit 52 and antenna 50 to another mobile telephone, to a cellular phone tower, to a satellite, etc. Operation of the radio circuit 52, sound processing signal circuit 54, speaker and microphone, are under control of the control circuit 42, as is conventional.

The mobile phone 10 may include the display device 22, keypad 24, 26 (including the navigation device mentioned above), and the capability of a touch screen 22a, which may be part or all of the display device 22, as is conventional; and these are coupled to the control circuit 42 for operation in conventional manner.

As was mentioned above, the mobile phone 10 includes a memory 46. The memory 46 may include a phone book for the mobile phone, and in the phone book, for example, are contacts or information pertaining to contacts. Sometimes such information is in the form of a VCARD. In using the mobile phone 10, a user may use the keys and navigation device 24, 26 and/or touch screen 22a to provide inputs to the control circuit 42 to access contacts in the memory 46 and/or to add or to delete contacts, to add, delete or change information pertaining to a contact, and/or to select a contact to cause the mobile phone to dial the telephone number of the contact, to send an email to the contact, to display an image of the contact, or for some other purpose. One of the contacts may be a personal contact, which includes information pertaining to the owner of the mobile phone, e.g., the owner's name, address(es), telephone number, email address(es), etc. The mobile phone may be used in conventional ways to make and to receive telephone calls.

As is illustrated in FIG. 3, the mobile phone 10 includes an input/output interface 56, a power supply 57, and a short distance communications mechanism 58, for example a Bluetooth communications device, infrared (IR) communications device, or some other device. Another example of a short distance communications mechanism is wireless local area network (WLAN), and the invention also may use still other short distance communications mechanisms or devices that currently exist or may be developed in the future. The short distance communications mechanism 58 may transmit and receive signals using SMS (short message service), MMS (multimedia messaging service) or some other communications mechanism and protocol. Bluetooth, IR, WLAN communications for communicating over short distances between mobile phones are well known; other mechanisms may exist and/or may be developed in the future, and these may be utilized by and may be included in the mobile phone 10.

Turning to FIGS. 4, 5 and 6, several examples of motion transducers 40 are illustrated. The motion transducer 40 shown in FIG. 4 includes a motion sensor 60, for example, an accelerometer or an acceleration transducer. The motion transducer 40 also may include signal processing circuitry, for example, motion signal processing circuit 62, which is described below. An accelerometer may provide a signal output, e.g., an electrical signal, representing acceleration of the transducer. The accelerometer may be in the case or housing 18 of the mobile phone 10. An accelerometer is useful to produce signals representing motion occurring as a user shakes the mobile phone back and forth while holding the mobile phone in the hand 14. The transducer may be a position sensor type transducer or a rotation sensing transducer, either of which may provide a signal output, e.g., an electrical signal, that represents the motion of or changes in location or orientation of the mobile phone.

It will be appreciated that a motion transducer may be any device, circuit or other mechanism or combination thereof that provides an indication that motion has been sensed and/or provides an indication of the character of the motion, such as, for example, acceleration, velocity, direction, directional change or any other characterization of the motion. An example, as is mentioned above, is an accelerometer that provides an electrical output (or some other output) in response to acceleration. Another example is a velocimeter that provides an output representative of velocity. Still another example is a signal detector that responds to changes in electrical signals, radio frequency signals, or some other signals, such as amplitude or frequency or changes therein, Doppler shift, or some other discernible change that occurs due to motion.

Another example of a motion transducer is a small generator, e.g., an electric generator. An example of such a generator is the type currently used in Seiko Kinetic wrist watches and chronometers. Such a generator may generate an electrical output in response to motion. The character of the electrical output from a small generator, e.g., duration, amplitude, frequency, or some other character, may be used to represent motion of the mobile phone.

Still another motion detection embodiment may use a Bluetooth system (or some other system) to detect signal variations or relationships. For example, with the Bluetooth radio turned on for the mobile phone 10, the radio and associated circuitry, e.g., motion signal processing circuitry 62, may be used to detect variations (or lack thereof) in the signals of one mobile phone and received from another Bluetooth radio, e.g., a radio in another mobile phone, in a hands-free earpiece that is a speaker and/or microphone, or in another device. Examples of signal variations may be Doppler shift, amplitude changes, frequency changes, etc., or lack thereof. The foregoing uses of signal variations as just described may be used with or without a separate motion transducer device to indicate occurrence and character of motion.

The motion transducer 40, as is shown in respective embodiments of FIGS. 4, 5 and 6, also includes a motion signal processing circuit, which is designated generically 62 in FIG. 3 and is designated individually in exemplary embodiments 62a, 62b, 62c, respectively, in FIGS. 4, 5 and 6. The motion sensor 60 produces an output indicative of motion of the mobile phone 10. This output is provided to the motion signal processing circuit 62 that processes and conditions the signal prior to being input to the control circuit 42. For example, the motion signal processing circuit 62 provides a motion signal to the control circuit 42 to indicate at least one of that motion has been detected, one or more characteristics of that motion, e.g., duration of the motion, amplitude of the motion, frequency (e.g., changes of direction) of the motion, etc. and/or that motion has ceased. The motion signal processing circuit 62 may filter the output of the motion sensor 60 or otherwise may condition the output using known techniques such that the indication of motion or an appropriate signal to represent motion to the control circuit 42 only is provided in instances where the user decidedly moves the mobile phone 10 in a prescribed manner, e.g., in a back and forth shaking motion or in some other prescribed manner, such as was described above or some other manner. Such motion is referred to as intended motion. The motion signal processing circuit 62 may block from the control circuit 42 signals representing brief or casual movement of the mobile phone 10, e.g., as a result of being dropped, placed on a table or other surface, carried by a user while walking or jogging, bouncing in a moving vehicle, etc. Therefore, the motion signal processing circuit 62 may require that the output from the motion sensor 60 be maintained for at least a predetermined time, amplitude and/or frequency prior to issuing a motion indication, e.g., that intended motion has been detected, to the control circuit 42. Alternatively, the motion signal processing circuit 62 may provide inputs to the control circuit 42 and the control circuit 42 may include appropriate circuitry and/or program code to effect the desired filtering, e.g., as was just described, to avoid false indications of motion detection of a type that would turn on or turn off keylock, etc., for example.

With the above in mind, then, each of the motion signal processing circuits 62a, 62b, 62c shown in FIGS. 4, 5 and 6 includes a low pass filter 64 and either a threshold detector 66, amplitude detector 68 or frequency detector 70. In another embodiment the motion signal processing circuit may include a combination of two or more of the detectors 66, 68, 70. The low pass filter 64 removes or blocks signals representing casual motion or noise or spurious signals representing brief, unintended movement of the mobile phone 10 or casual movement of the mobile phone, such as may occur during walking, jogging or bouncing in a moving vehicle. The threshold detector 66 is designed to output an appropriate motion signal on line 72, which is coupled as an input to the control circuit 42, when motion of a relatively long duration occurs, e.g., probably not due to casual motion, noise or the like. In response to such motion signal the control circuit 42 effects operation of the mobile phone 10 to transmit data to another mobile phone, e.g., mobile phone 12, and/or to receive data from such other mobile phone. The threshold detected by the threshold detector 66 may be represented by pulse width of signals input thereto, and the output therefrom may be representative of such pulse width, as is represented by the relatively short and long pulse width signals 66a, 66b. The signal provided on line 72 to the control circuit 42 may be of a shape, form, duration, etc., similar to the signals 66a, 66b, may be respective high or low signals, depending on the duration of the signals 66a, 66b, may be a digital signal value of a prescribed number of data bits in length, or may be of some other character that is suitable to effect a desired operation of the control circuit 42 depending on whether or not intended motion that is to cause turning on or off keylock. As several examples, the cutoff or distinguishing duration of pulse widths representing the motion detected to distinguish between intended motion and casual motion or noise may be from about a fraction of a second to up to three or four seconds; these are just exemplary and the duration or pulse width of occurrence of such motion may be more or less.

As another example of motion signal processing circuit 62b, there is illustrated in FIG. 5 a low pass filter 64 and an amplitude detector 68. The amplitude detector 68 provides an output on line 72, e.g., of a type suitable for the control circuit 42 to understand and to operate based on whether intended or prescribed motion has been detected or has not been detected. For example, casual motion or noise may produce a relatively low amplitude signal 68a as input or output from the amplitude detector; and intended or prescribed motion may produce a relatively larger amplitude signal 68b as input or output to/from the amplitude detector 68.

Still another example of motion signal processing circuit 62c is illustrated in FIG. 6 as a low pass filter 64 and a frequency detector 70. The frequency detector 70 provides an output on line 72, e.g., of a type suitable for the control circuit 42 to understand and to operate based on whether intended or prescribed motion has been detected or has not been detected. For example, casual motion or noise may produce a relatively low frequency signal 70a or respond to a relatively low frequency signal 70a, respectively, as output from or input to the amplitude detector. A relatively higher frequency signal 70b input to and/or output from the frequency detector 70 representing detection of intended motion, may be provided to the control circuit 42.

It is noted here that a mobile phone is but one non-limiting example of an electronic equipment, which is more broadly defined above. In response to detecting intended motion the mobile phone turns on keylock if keylock was off and turns off keylock if keylock is on. According to another embodiment, one or more different functions of the mobile phone other than keylock or in addition to keylock may be turned on or off in response to detecting intended motion. According to still another embodiment in response to detecting different respective motions, e.g., different respective frequencies, different respective directions, such as generally linearly compared to twisting or rotating the mobile phone, different respective functions of the mobile phone may be turned on and turned off, etc.

A person having ordinary skill in the art of computer programming and applications of programming for mobile phones would be able in view of the description provided herein to program a mobile phone 10 to operate and to carry out the functions described herein. Accordingly, details as to the specific programming code have been omitted for the sake of brevity. Also, while software in the memory 46 or in some other memory of the mobile phone may be used to allow the mobile phone to carry out the functions and features described herein in accordance with the embodiments of the invention, such functions and features also could be carried out via dedicated hardware, firmware, software, or combinations thereof, without departing from the scope of the invention.

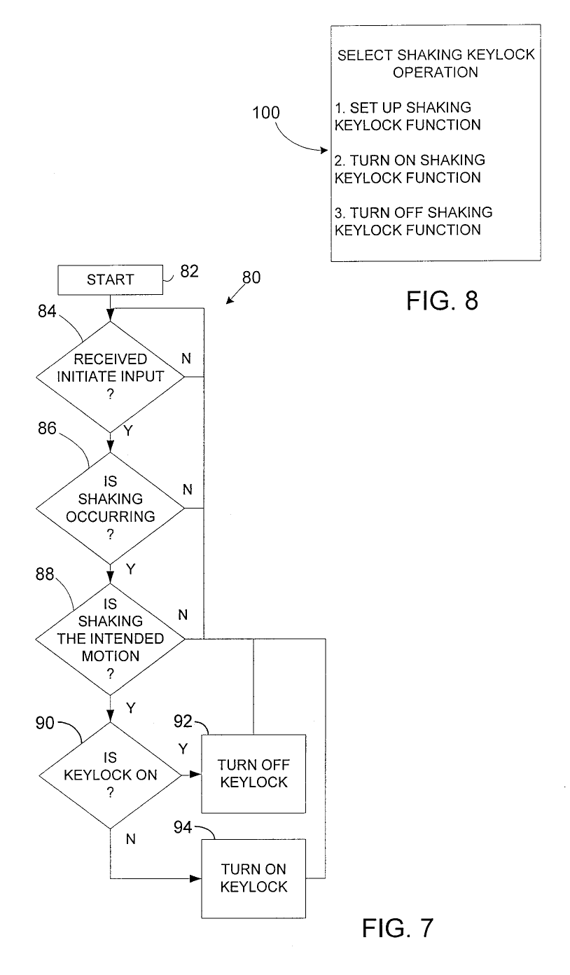

FIG. 7 illustrates a representative flow chart 80 showing an example of steps, functions and methods that may be carried out using the invention. The steps shown in the flow chart may be carried out using a mobile phone, for example, of the type described herein or other type. Appropriate programming code may be written in an appropriate computer language or the like to carry out the steps, functions and methods as now are described with respect to FIG. 7. The steps shown in the flow chart are referred to below as blocks. The letter “Y” designates a “yes” or affirmative answer to an inquiry, and the letter “N” designates a “no” or negative answer to the inquiry.

At block 82 the method starts. Starting may include turning on the cell phone 10, and pressing an appropriate key to indicate that the motion responsive information transfer function(s) is(are) to be carried out. At block 84 an inquiry is made whether an initiate signal has been input, e.g., whether a key has been pressed, the mobile phone has been turned on, etc. If not, then the flow chart loops back to the input to block 84 until such initiate input is received.

At block 86 an inquiry is made to determine whether motion, e.g., shaking or other prescribed type of motion, for example, of the types described above or some other intended type, is occurring. If not, then a loop is followed back to block 84. It is noted here that the looping back as described here and with respect to other loops mentioned below, may be back to a beginning portion of the flow chart 80, e.g., to the input to block 84, or the loop may be back upstream in the flow chart to some other location. For example, the negative loop followed from block 86 may be back to the input of block 86 rather than to the input to block 84.

If shaking of the intended motion type is occurring as detected at block 86, then at block 88 the threshold detector 66, amplitude detector 68 and/or frequency detector 70 determines whether such motion is intended motion. If it is not, then a loop is followed back to block 84; but if intended motion is detected, then at block 88 the output from the threshold, amplitude and/or frequency detector is provided to the control circuit 42 to turn on keylock, to turn off keylock, or to perform one or more functions in addition to or instead of keylock.

At block 90 an inquiry is made whether keylock is turned on; this inquiry is made if shaking is occurring and the shaking is the intended motion. If keylock is turned on (a yes “Y” at block 90), then at block 92 keylock will be turned off. If keylock is turned off (a no “N” at block 90), then at block 94 keylock will be turned on. Similar operation may occur if the shaking or motion were to turn on or to turn off other mobile phone functions. After turning on or off the keylock function, the program logic routine 80 returns to block 84 or elsewhere as may be programmed in the mobile phone.

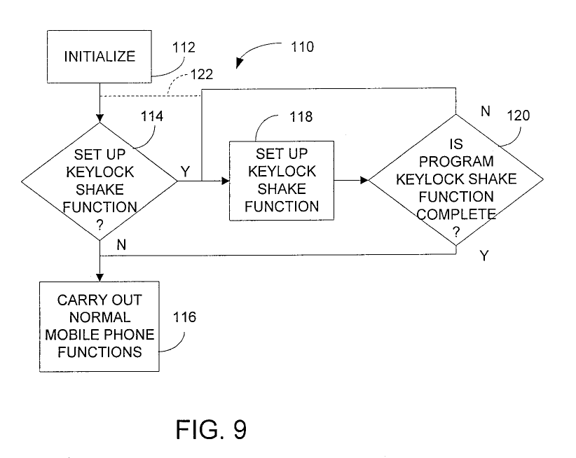

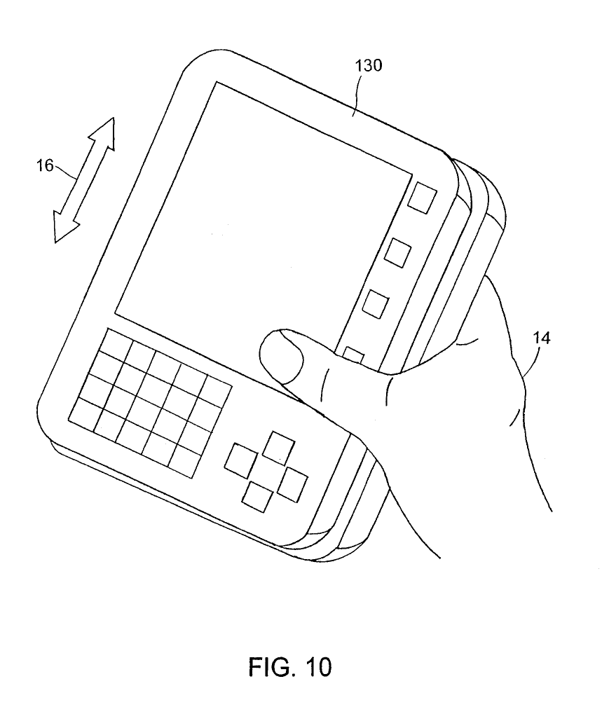

Briefly referring to FIG. 8, an exemplary menu 100 is illustrated. Such menu may be displayed on the display 22 of the mobile phone 10. Three functions are shown in the menu pertaining to shaking functions. Those functions may be selected using a stylus or finger pressing on a touch screen area where respective functions are shown or by navigating to and selecting a function using navigation device 24 and associated keys and/or keys 26 of the mobile phone keypad. Set up shaking is selected, then a setup routine, which is described below with respect to FIG. 9, is called. If turn on shaking keylock is selected then the operation described above whereby keylock is turned on or off by shaking, e.g., as is summarized with respect to the description of FIG. 7, is called. If turn off shaking keylock is selected, then the use of shaking to turn on or to turn off keylock is disabled. As was described above, instead of keylock or in addition to keylock, shaking may be used to control other mobile phone functions.

FIG. 9 represents an exemplary method in the form of a flow chart 110 of steps for programming or setting up the keylock shake function. Using the steps of FIG. 9 flow chart 110 the keylock shake function can be set up, for example, as is described just below. However, it will be appreciated that other steps may be used to set up the keylock shake function or some other function that is turned on, turned off, or carried out by shaking, as will be appreciated by those having ordinary skill in the art.

At block 112 the mobile phone 10 is initialized. For example, power is turned on and other initialization steps of the mobile phone 10 may be carried out automatically or according to selections made on various menus, e.g., from the menu 100 (FIG. 8). The first menu selection, “1. Set up shaking keylock function” may be selected from the menu 100. An inquiry is made at block 114 whether keylock shake function is to be set up. If not, then at block 116 normal mobile phone functions, possibly including other initialization functions, may be carried out according to the particular mobile phone and functions that are available for it. Also, if keylock shake function already has been set up, then it, too, would be operational according to normal mobile phone functions, e.g., as was described above with respect to the method illustrated by the flow chart 80 of FIG. 7.

However, if at block 114 keylock shake function is to be set up, then at block 118 the keylock shake function is set up. Setting up keylock shake function may include one or several steps. As one example, the mobile phone is moved relatively rapidly in a vertical direction up and then down a number of times, the number being determined by the user. For example, the user may rapidly move the mobile phone up and down three times to establish a setup condition whereby each time the mobile phone is moved rapidly up and down three times the keylock function would be turned on or would be turned off, respectively, depending on the condition existing just prior to the shaking, as was described above. As another example of a setup operation, the user may move the mobile phone rapidly up and down three times, then pause for several seconds, e.g., two to five seconds (or any other time period determined by the user), and then move the mobile phone rapidly up and down two more times; although this routine is more complex, it minimizes the possibility of accidentally turning on or off the keylock shake function. Still other examples may include shaking the mobile phone rapidly a determined number of times followed by shaking the phone slowly a determined number of times. Another example may include holding the mobile phone in the hand and twisting the wrist a determined number of times or moving the mobile phone in an arc.

At block 120 an inquiry is made whether the keylock shake function setup has been completed, e.g., has that function been properly programmed for the mobile phone 10. If keylock shake function setup programming has been completed, then the routine follows to block 116 for normal mobile phone functions to be carried out. If keylock shake function setup has not been completed, as is inquired at block 120, then the routine would follow back to block 118 to set up keylock shake function or, alternatively to the input to the inquiry block 114, as is represented by the dash broken line 122 in FIG. 9. The negative response at block 120 may be, for example, due to a timeout function, due to an input by the user, e.g., pressing a restart function, turning off the mobile phone, selecting a menu function from a menu shown on the mobile phone display, etc.

Briefly referring back to FIG. 8, the user may select the second listed item to turn on the shaking keylock function; and in this case the routine 110 of FIG. 9 may flow from the block 112, via block 114, directly to block 116 to carry out normal mobile phone operation unless at block 114 it is determined that the shaking keylock function has not yet been set up. If the program keylock function has not yet been set up, then various options are possible. Several examples of such options are presented. For example, the fact that shaking keylock function had not been set up may be ignored, and the routine 110 of FIG. 9 may simply proceed to normal mobile phone operation at block 116 without shaking keylock function. Alternatively, the user may be given the option of setting up (or not setting up) the shaking keylock function, as was described above with respect to FIG. 9. If the third selection in the menu 100 is selected by the user, then normal mobile phone operation may be carried out without regard to whether or not the shaking keylock function had been set up.

Sometimes the intended motion or shaking may be defined as determined motion or even as predetermined motion, etc., as it may be determined during setup of the mobile phone by a user, during manufacturing of the mobile phone, during changing of the determined motion or at some other time, etc.

In FIG. 10 is illustrated a PDAs 102 with which the invention may be used according to the description herein. The invention also may be used with mobile phones that include PDA features and functions.

It will be appreciated that the flow charts 80, 110 are exemplary of operation of the invention and carrying out the method of the invention. Accordingly, various other steps, procedures, etc. may be used instead of or in addition to the steps and processes that are described above to achieve turning on or of keylock function and/or other functions of a mobile phone or other electronic equipment.

As will be appreciated by one of ordinary skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An electronic equipment, comprising
a transducer, wherein the transducer is operable to detect motion of the electronic equipment,
the electronic equipment having at least one operational function, and wherein the operational function or a characteristic of the operational function is responsive to detected motion at least one of to be turned on, to be turned off or to be altered.

2. The electronic equipment of claim 1, wherein the operational function is keylock, and wherein if the keylock function off detected motion turns on the keylock function and if the keylock function is on detected motion turns off the keylock function.

3. The electronic equipment of claim 2, wherein the electronic equipment is a mobile phone.

4. The electronic equipment of claim 3, wherein the electronic equipment includes a setup function operable to set up a prescribed motion detectable to turn on or to turn off the keylock function of the mobile phone.

5. An electronic equipment, comprising
a transducer, wherein the transducer is operable to detect motion of the electronic equipment,
a keylock, wherein the keylock turns on or turns off an operational function of the electronic equipment in response to the detected motion.

6. The electronic equipment of claim 5, wherein the transducer is responsive to a predetermined motion, and the keylock is operational to turn on or to turn off the operational function of the equipment only in response to such predetermined motion being detected.

7. The electronic equipment of claim 6, wherein said electronic equipment is a mobile phone.

8. The electronic equipment of claim 6, wherein said electronic equipment is at least one of a mobile phone and a PDA.

9. The electronic equipment of claim 6, wherein the transducer is operable to detect shaking.

10. The electronic equipment of claim 5, said transducer comprising an accelerometer.

11. The electronic equipment of claim 5, said transducer comprising a signal conditioning circuit to filter out signals representing motion not representative of intended motion of the electronic equipment.

12. The electronic equipment of claim 11, said signal conditioning circuit comprising a low pass filter.

13. The electronic equipment of claim 5, said transducer comprising a signal variation detector.

14. The electronic equipment of claim 5, further comprising programmable device responsive to a motion input, whereby a determined motion of the electronic equipment may be used to establish the detectable motion required to be detected to turn on or to turn off the operational function.

15. A method of activating and deactivating a function of electronic equipment, comprising
moving an electronic equipment, detecting such moving, and in response to said moving at least one of turning on, turning off or altering a characteristic of the function.

16. The method of claim 15, further comprising detecting the character of movement of such electronic equipment, comparing such movement with an already determined character of movement, and in response to such movements being at least substantially the same turning on, turning off or altering a characteristic of the function.

17. The method of claim 16, said moving comprising manually shaking.

18. The method of claim 16, said turning, turning off or altering a characteristic of the function comprises turning on, turning off or altering a characteristic of keylock of a mobile phone.

19. The method of claim 18, further comprising the step of setting up the electronic equipment to establish the determined character of movement to which subsequent movement may be compared to determine whether to turn on, to turn off or to alter a characteristic of the function.

20. The method of claim 15, further comprising detecting for variations in signals produced by two electronic equipment for use in determining whether to establish communication therebetween.

21. A method for programming electronic equipment to be responsive to motion to at least one of turn on, turn off or to alter a function or a characteristic of a function, comprising moving the electronic equipment in a desired manner to establish the determined character of movement to which subsequent movement may be compared to determine whether at least one of to turn on, to turn off or to alter a function or a characteristic of the function.

22. A computer program operable in electronic equipment, comprising
code to operate the electronic equipment to detect the character of motion of such electronic equipment,
code to cause comparing of the character of motion of such electronic equipment with a determined motion signal representing determined motion, and
code for causing at least one of turning on, turning off or altering of a function of the electronic equipment when the character of motion of such electronic equipment and such determined motion signal represent substantially the same motion.
